(19) United States
(12) Patent Application Publication
(10) Pub. No.: US 2025/0299189 A1
(43) Pub. Date: Sep. 25, 2025

(54) OPTIMISTIC RECEIPT OF NON-FUNGIBLE TOKENS IN A BLOCKCHAIN ADDRESS APPLICATION

(71) Applicant: Coinbase, Inc., Oakland, CA (US)

(72) Inventors: Amit Shah, Georgetown, CA (US); Calvin Rempel, Kimberley, CA (US); Chintan Turakhia, Piedmont, CA (US); Si Wan Kim, Torrance, CA (US)

(21) Appl. No.: 18/614,402

(22) Filed: Mar. 22, 2024

(51) Int. Cl. G06Q 20/40; G06Q 20/38

(52) U.S. Cl. CPC G06Q 20/401; G06Q 20/389

(57) ABSTRACT

Methods, systems, and devices for data management are described. A blockchain address application may receive information indicating that a device supporting the blockchain address application accesses a first link associated with the blockchain address application, where the information indicates a non-fungible token (NFT). The blockchain address application may display, via a user interface, a first indication of the NFT and a second indication that the NFT is transferred to a first blockchain address associated with the blockchain address application. The blockchain address application may initiate execution of an on-chain transfer the NFT from a second blockchain address associated with an NFT collection including the NFT to the first blockchain address after receiving the information. The blockchain address application may display the first indication of the NFT and a status associated with the on-chain transfer, where the status is pending until confirmation of the on-chain transfer via a blockchain network.

### FIELD OF TECHNOLOGY

The present disclosure relates generally to data management, including techniques for optimistic receipt of non-fungible tokens (NFTs) in a blockchain address application.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support optimistic receipt of non-fungible tokens (NFTs) in a blockchain address application in accordance with aspects of the present disclosure.

FIG. 3 shows an example of a user interface flow that supports optimistic receipt of NFTs in a blockchain address application in accordance with aspects of the present disclosure.

FIG. 4 shows an example of a process flow that supports optimistic receipt of NFTs in a blockchain address application in accordance with aspects of the present disclosure.

FIG. 5 shows a block diagram of an apparatus that supports optimistic receipt of NFTs in a blockchain address application in accordance with aspects of the present disclosure.

FIG. 6 shows a block diagram of a blockchain address application that supports optimistic receipt of NFTs in a blockchain address application in accordance with aspects of the present disclosure.

FIG. 7 shows a diagram of a system including a device that supports optimistic receipt of NFTs in a blockchain address application in accordance with aspects of the present disclosure.

FIGS. 8 and 9 show flowcharts illustrating methods that support optimistic receipt of NFTs in a blockchain address application in accordance with aspects of the present disclosure.

### DETAILED DESCRIPTION

A blockchain network may support an exchange of digital assets, including non-fungible tokens (NFTs). For example, a user of a blockchain address application may purchase an NFT. After the user purchases the NFT, an issuer of the NFT may mint and transfer the NFT to a blockchain address associated with the user via the blockchain network. For example, to mint the NFT, the issuer may generate a token on the blockchain and establish a record of ownership of the token stored on the blockchain network. That is, the issuer may establish an immutable record on the blockchain network of ownership of the NFT by associating the minted NFT with the blockchain address. Additionally, or alternatively, the minting may involve establishing provenance of the NFT by generating metadata associated with the NFT including, as an example, information associated with the creator. After a user purchases the NFT (e.g., via a transfer via the blockchain), a duration of time may lapse during which the NFT is minted and/or transferred to the blockchain address of the user. In some cases, the user may be unable to view the NFT or an indication of a status of the minting or transfer until the transfer is complete (e.g., verified on the blockchain network).

As described herein, a blockchain address application may support transfer of pre-minted NFTs and display of indications of the NFT and a status associated with transfer of the NFT prior to completion or verification of the transfer. For example, a user of the blockchain address application may access a link, where access to the link triggers a transfer of an NFT from a pre-minted NFT collection at a second blockchain address to a first blockchain address of the user. The NFT may be minted prior to access to the link by the user. For example, a service that manages the NFT collection may mint and store the NFT and one or more additional NFTs at the second blockchain address. In some examples, the NFT collection may be a smart contract wallet. In other words, the second blockchain address may be associated with a self-executing program. For example, the self-executing program may initiate transfer of the NFT to the first blockchain address associated with the user based on a triggering event. As an example, the triggering event may be receiving an indication from the blockchain address application (e.g., on the user device) that the user has accessed the link. After the user accesses the link and while the NFT is being transferred from the NFT collection, the blockchain address application may display an indication of the NFT and a status of the transfer. That is, the user may view the NFT and the status immediately after accessing the link.

Particular aspects of the subject matter described in this disclosure may be implemented to realize one or more of the following potential advantages. By minting the NFT prior to the user accessing the link, a user experience related to purchasing NFTs may be improved relative to minting the NFT after purchase. For example, a user purchasing a pre-minted NFT may receive the NFT after a shorter time duration relative to purchasing an NFT that is minted after purchase. Additionally, or alternatively, by displaying the indication of the NFT and the status of the transfer, a user experience related to purchasing the NFT may be improved relative to displaying the NFT only after the transfer is complete. For example, the user experience may be improved in accordance with the NFT and transfer status being optimistically displayed after purchase (e.g., displayed prior to the transfer being complete on the blockchain network). In other words, display of the NFT and the status prior to completion of the on-chain transaction may improve user experience compared to displaying the NFT after the transfer on the blockchain network.

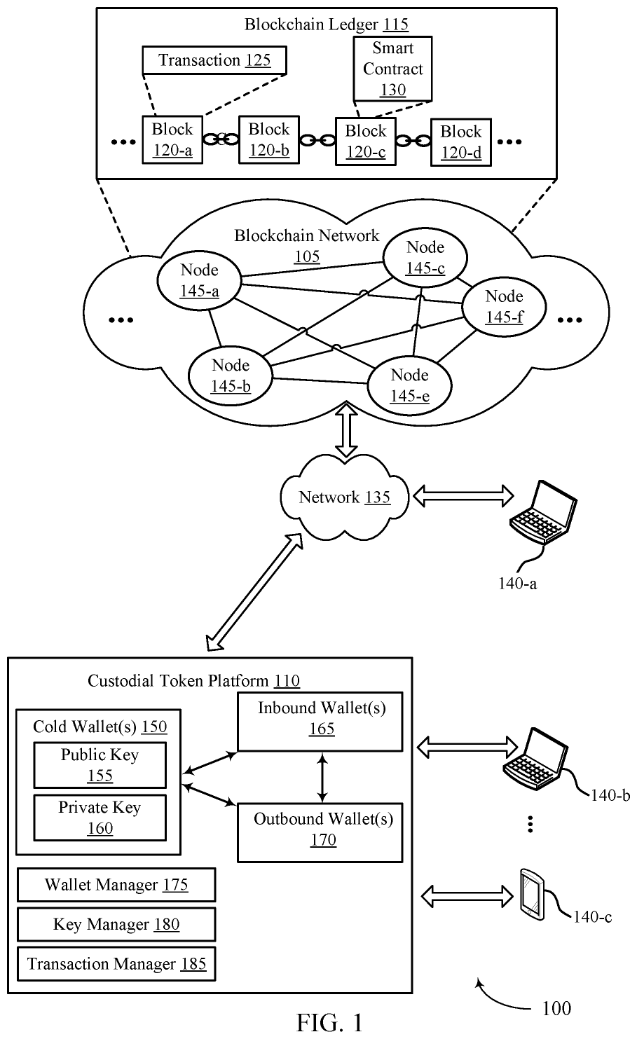

FIG. 1 illustrates an example of a computing environment 100 that supports optimistic receipt of NFTs in a blockchain address application in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, NFTs, and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

As described herein, a blockchain address application may support transfer of pre-minted NFTs and display of indications of the NFT and/or a status associated with transfer of the NFT prior to completion of the transfer. The blockchain address application may be supported by or otherwise associated with the custodial token platform 110. Additionally, or alternatively, the blockchain address application may be accessible via one or more of the computing devices, such as the computing device 140-b and/or the computing device 140-c. A user may access a link to the blockchain address application associated with an NFT, where access to the link triggers the blockchain address application to initiate a transfer of the NFT to a blockchain address associated with the user via the blockchain network 105. For example, the blockchain address application may communicate with a service that manages an NFT collection including the NFT, where the NFT collection is associated with a second blockchain address at which the NFT is stored. In some examples, the NFT collection may be associated with a smart contract, such as the smart contract 130. That is, the NFT collection may include a sub-program that may be deployed to the blockchain and executed when one or more conditions defined in the smart contract 130 are satisfied. As an example, the one or more conditions may include access to the link by the user, receiving an indication from the blockchain address application that an NFT is to be transferred to the blockchain address, or the like. After the user accesses the link and while the NFT is being transferred from the NFT collection, the blockchain address application may display an indication of the NFT and a status of the transfer via a user interface of a computing device (e.g., the computing device 140-b or the computing device 140-c).

As described, techniques described herein support “optimistically” displaying an NFT in a user's blockchain address application. Transacting via a blockchain network may necessarily involve delays due to the distributed computing functionality inherent in blockchain networks. For example, it may take seconds or minutes to add a transaction to a distributed ledger via a blockchain network, dependent on the network protocol. Further, it may take additional second or minutes for the block including the transaction to be validated or be confirmed to be included in the canonical chain thereby validating the transaction. Thus, actual transfer of an NFT (in addition to other tokens) to a user address may take significant amount of time, which may result in undesirable user experiences. Techniques described herein support display of an NFT (that is being transferred to the user's address) before the NFT is actually transferred (e.g., confirmed) to the user's address. That is, by triggering initiation of the transfer and displaying the NFT prior to completion of the transfer (e.g., using the API techniques), user experience with interacting with blockchain systems may be improved. Additionally, because the blockchain application is configured to monitor for completion of the transfer, the user is able to view the current status of the NFT in real-time or near real-time, thereby supporting improved interaction with blockchain networks. Thus, the application is configured with functionality (e.g., API functionality) to display the NFT prior transfer of the NFT and without requiring a digital signature to be activated by the user. Additionally, because the NFT may be transferred without requiring a user to execute a digital signature using the blockchain address application, computing overhead may be reduced both on the user device and in the blockchain network. That is, the user device saves resources by not having to perform a digital signature and communicate the resulting package, and nodes 145 of the blockchain network may reduce resource overhead by not having to validate the signature.

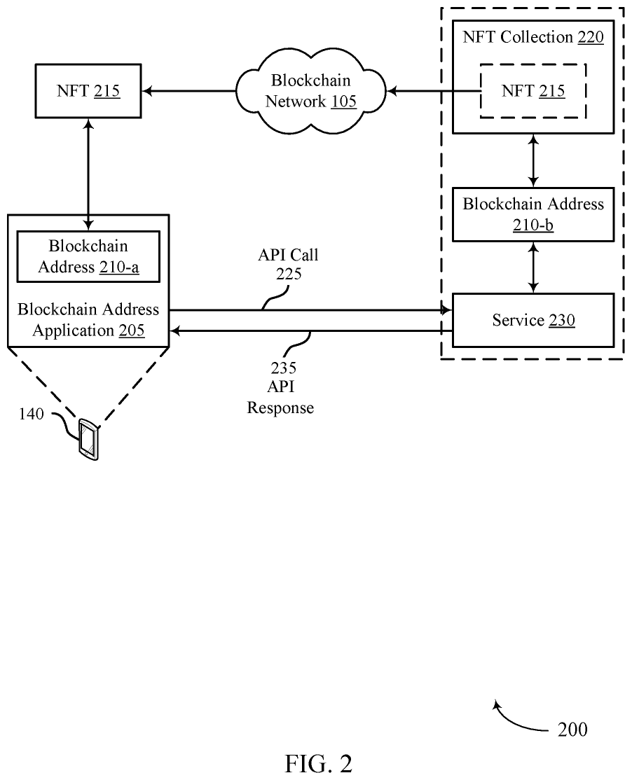

FIG. 2 shows an example of a computing environment 200 that supports optimistic receipt of NFTs in a blockchain address application in accordance with aspects of the present disclosure. The computing environment 200 may include a blockchain network 105 and a computing device 140 which may be examples of the blockchain network 105 and the computing device 140, respectively, as described with reference to FIG. 1. The computing environment 200 may also include a blockchain address application 205, which may be supported by or implemented by a custodial token platform 110 or another system or service as described with reference to FIG. 1.

In some examples, the blockchain address application 205, which may be an example of a self-custodial blockchain wallet application, may support optimistic display of NFTs. For example, the blockchain address application 205 may display an NFT and/or a status of an on-chain transfer of the NFT prior to completion of the on-chain transfer. Additionally, or alternatively, the blockchain address application 205 may support transfer of pre-minted NFTs.

For example, a user of the blockchain address application 205 may access a link associated with an NFT 215. That is, the NFT 215 may be accessible to purchase or receive via the link. In some examples, the link may route the user to the blockchain address application 205. In other words, the link may be associated with the blockchain address application 205. In some examples, accessing the link may trigger the blockchain address 210-a to initiate transfer of the NFT 215 to a blockchain address 210-a associated with the user from a blockchain address 210-b associated with an NFT collection 220.

For example, when the user accesses the link on the computing device 140, the blockchain address application 205 may receive information indicating that the computing device 140 accesses the link. The link may include a uniform resource identifier (URI) and/or a deep link with information related to the NFT 215 and one or more actions to be performed by the blockchain address application 205. For example, the information may cause the blockchain address application 205 to launch (e.g., if not already open) on the computing device 140, to open at a location within the blockchain address application 205, or both. For example, the location may be an NFT tab within the blockchain address application 205. In some examples, the location may be a full-screen takeover indicating the NFT 215 and/or a status of a transfer of the NFT 215 (e.g., pending) within the blockchain address application 205. That is, the blockchain address application 205 may display an indication of the NFT 215 and/or the status on a user interface of the computing device 140 according to the information included in the link.

In response to accessing or receiving information associated with the link, the blockchain address application 205 may access a content management system to retrieve an image of the NFT 215 based on the link. For example, blockchain address application 205 may display the NFT 215 at the user interface of the computing device 140 prior to completion of the transfer of the NFT 215 to the blockchain address 210-a by accessing the content management system. To display the NFT 215 prior to transfer of the NFT 215, the blockchain address application 205 may receive an indication of the NFT 215 in response to an API call 225, as described herein.

The NFT 215 of the NFT collection 220 may be pre-minted. That is, the service 230 may mint a quantity of NFTs, including the NFT 215, prior to user access to a link associated with the NFTs. The quantity of NFTs may represent copies (e.g., replications, duplicates, etc.) of a same NFT or may be different NFTs or variations of NFTs. In some examples, the service 230 may generate the link associated with the NFTs after minting of the quantity of NFTs. That is, the service 230 may generate the link in accordance with the NFTs having already been minted, and the link may include information about the minted NFT. In some examples, the service 230 may generate different links for different NFTs. That is, the NFT collection 220 may include multiple different NFTs, and a user may become eligible for receipt of the NFTs by accessing different links associated with each respective NFT. In other words, the user may access a second link (e.g., different than the link) via the computing device 140 to obtain a second NFT (e.g., different than the NFT 215). In some examples, one or more NFTs of the NFT collection 220 may be non-transferrable (e.g., a soulbound token). In other words, NFTs of the NFT collection 220 may not be transferred to another blockchain address after being transferred to the blockchain address 210-a.

In some examples, the blockchain address application 205 may initiate transfer of the NFT 215 to the blockchain address 210-a based on receiving the information indicating that the computing device 140 accesses the link. In other words, the blockchain address application 205 may (e.g., simultaneously) display the NFT 215 via a user interface of the computing device 140 and initiate transfer of the NFT 215 to the blockchain address 210-a after receiving the information. Initiating transfer of the NFT 215 to the blockchain address 210-a may include transmitting an API call 225 to a service 230. That is, the initiation of the transfer of the NFT 215 may be off-chain. The API call 225 may include an indication of the NFT 215 and the blockchain address 210-a. In other words, the API call 225 may indicate, to the service 230, that a user associated with the blockchain address 210-a is eligible for receipt of the NFT 215. The service 230 may transfer the NFT 215 to the blockchain address 210-a based on receiving the API call 225 and according to the indication of the NFT 215 and the blockchain address 210-a in the API call 225. That is, receipt of the API call 225 at the service 230 may cause the service 230 to initiate an on-chain transaction via the blockchain network 105 resulting in transfer of the NFT from the blockchain address 210-b to the blockchain address 210-a.

To display the NFT 215 prior to completion of the transfer, the service 230 may respond to the API call 225 with an API response 235 that includes the indication of the NFT 215 and/or instructions to display the NFT at the blockchain address application 205. Thus, the API call 225 may trigger execution of the on-chain transfer of the NFT 215 and display of the indication of the NFT 215 (prior to completion of the transfer) via the API response 235.

In some examples, the service 230 may support the NFT collection 220 including the NFT 215. Additionally, or alternatively, the blockchain address 210-b at which the NFT 215 of the NFT collection 220 is stored may be associated with a self-executing program managed by the service 230. For example, the self-executing program (e.g., smart contract) may be stored on the blockchain network 105 and may execute the transfer of the NFT 215 when conditions for the transfer are met. As an example, the conditions may include an eligibility of a user to receive the NFT 215, which may be met via receipt of the API call 225 at the service 230. In other words, receipt of the API call 225 at the service may trigger the self-executing program supported by the blockchain network 105 to transfer the NFT 215 from the blockchain address 210-b via the blockchain network 105.

The transfer of the NFT 215 from the blockchain address 210-b to the blockchain address 210-a may occur without a transfer from the blockchain address 210-a. In other words, the transfer of the NFT 215 may be gasless from the perspective of the user associated with the blockchain address 210-a. In some examples, the transfer of the NFT 215 may occur without the transfer from the blockchain address 210-a based on the blockchain address 210-a being associated with the blockchain address application 205. For example, the blockchain address application 205 may subsidize a cost of the transfer of the NFT 215 via the blockchain network 105.

Additionally, or alternatively, the transfer of the NFT 215 from the blockchain address 210-b to the blockchain address 210-a may occur without a digital signature from the blockchain address 210-a. In other words, the blockchain address application 205 may initiate the execution of the transfer of the NFT 215 (e.g., by transmitting the API call 225) absent a digital signature from the blockchain address 210-a. For example, the blockchain address application 205 may indicate the blockchain address 210-a to the service 230 as a recipient of the NFT 215, where the transfer of the NFT 215 occurs based on the indication of the blockchain address 210-a (e.g., rather than a digital signature from the blockchain address 210-a).

The blockchain address application 205 may monitor for completion of the transfer of the NFT 215 via the blockchain network 105. For example, the blockchain address application 205 may include one or more processors, including a block processor, which monitor for on-chain events. Additionally, or alternatively, the blockchain address application may receive an indication of the transfer via the service 230 which may use a block processor for monitoring the transfer on the blockchain network 105. The blockchain address application 205 and/or the service 230 may monitor for the on-chain events periodically (e.g., every one minute). Additionally, or alternatively, the blockchain address application 205 may monitor for a webhook event to be triggered. For example, the webhook may be triggered when the NFT 215 is received at the blockchain address 210-a (e.g., when the on-chain transfer is complete). The webhook may trigger execution of a backend process and/or an on-chain message.

As an example, the webhook may trigger a removal of display of the status of the transfer at the blockchain address application 205 on the computing device. For example, after the transfer of the NFT 215 is complete (e.g., executed) on the blockchain network 105, the blockchain address application 205 may display the NFT 215 without the indication of the status. In other words, the blockchain address application 205 may display the NFT 215 absent a pending status after the transfer is complete. In some examples, the display of the NFT 215 absent the status may be based on (e.g., in response to) the webhook being triggered.

Additionally, or alternatively, the webhook may trigger an on-chain message. For example, the webhook may trigger a second NFT to be transferred to the blockchain address 210-a when the user is associated with a quantity of NFTs exceeding a threshold. In other words, the webhook may be triggered by the occurrence of the receipt of the NFT 215 at the blockchain address 210-a, where the webhook may execute an on-chain message in order to transfer the second NFT to the blockchain address 210-a. In some aspects, each NFT transferred to the blockchain address 210-a may be associated with a quantity of points. For example, the webhook may be triggered by the blockchain address 210-a accumulating a quantity of points which exceeds one or more thresholds, where each of the one or more thresholds are associated with transfer of different NFTs to the blockchain address 210-a.

While the service 230 in the example of FIG. 2 is illustrated and described as executing transfer of the NFT 215, it may be understood that the service 230 may additionally or alternatively support executions of smart contracts generally. For example, the service 230 may allow for general contract execution in which an asset, such as a cryptographic token or, in the example of FIG. 2, the NFT 215, may be transferred to the blockchain address 210-a after the blockchain address 210-a triggers an event. General contract execution may be supported by using templated parameters that may be used to inject the blockchain address 210-a, which triggered the event (e.g., API call 225), into a contract call.

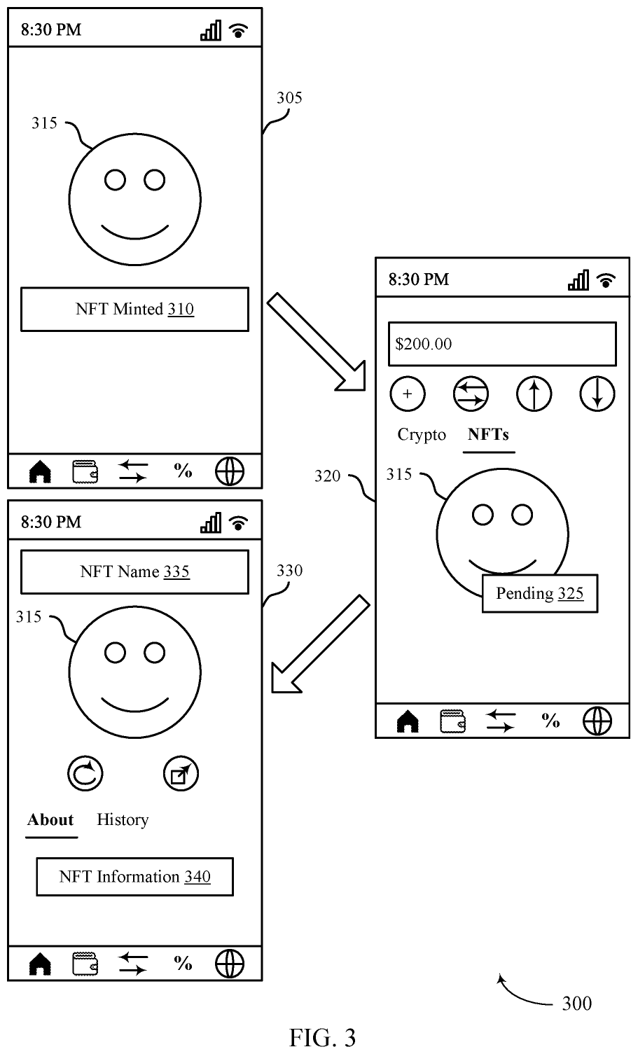

FIG. 3 shows an example of a user interface flow 300 that supports optimistic receipt of NFTs in a blockchain address application in accordance with aspects of the present disclosure. In some examples, the user interface flow 300 may implement or be implemented by aspects of the computing environment 100 and/or the computing environment 200 as described with reference to FIGS. 1 and 2. For example, the user interface flow 300 may illustrate a display of one or more indications at a blockchain address application, such as the blockchain address application 205 as described with reference to FIG. 2. Alternative examples of the following user interface flow may be implemented, where display of some indications may be in a different order than described or are not displayed at all. In some cases, the user interface flow 300 may include additional indications not mentioned below, or further indications may be added.

A user interface may display multiple content items in accordance with optimistic receipt of NFTs in a blockchain address application as described herein. The user interface flow 300 includes an example of the user interface where multiple content items may be displayed to enable a user to view a status of an NFT on the blockchain address application.

At 305, the blockchain address application may display an indication that the NFT is minted 310 and the NFT 315. For example, the blockchain address application may display the indication that the NFT is minted 310 and the NFT 315 in a full-screen takeover of the blockchain address application. The blockchain address application may display the full-screen takeover based on a user of a computing device having the user interface accessing a link. For example, the link may be associated with the NFT 315, and access to the link may trigger the blockchain address application to display the full-screen takeover and initiate transfer of the NFT 315 to a blockchain address associated with the user. In some aspects, the blockchain address may display the NFT 315 prior to an on-chain transfer of the NFT 315 to the blockchain address. In other words, the blockchain address application may optimistically display the NFT 315.

At 320, the blockchain address application may display the NFT 315 and a pending status 325. For example, when the user exits the full-screen takeover displayed at 305, the NFT 315 may be displayed under an NFT tab of the blockchain address application. In some examples, the blockchain address application may display the pending status 325 based on monitoring for completion of the on-chain transfer of the NFT 315 to the blockchain address. In other words, the blockchain address application may display the pending status 325 until the on-chain transfer of the NFT 315 is detected/confirmed.

At 330, the blockchain address application may display the NFT 315, an NFT name 335, and NFT information 340. The NFT name 335 and the NFT information 340 may be accessible prior to completion of the on-chain transfer of the NFT 315. For example, prior to the completion of the on-chain transfer of the NFT 315, the blockchain address application may display the NFT 315 at 330 with the pending status 325. In the example of FIG. 2, however, the on-chain transfer of the NFT 315 may be completed at 330. That is, the blockchain address application may display the NFT 315 without the pending status 325 at 330 after completion of the on-chain transfer.

The NFT information 340 may include a description, a quantity of items, a quantity of owners, a floor price, and/or a volume associated with a time span (e.g., a seven-day volume). Additionally, or alternatively, the NFT information 340 may include one or more attributes of the NFT, such as an artist, a date, a location, a season, and/or a series.

While not shown in the example of FIG. 2, the blockchain address application may display a history of the NFT 315. For example, if the user selects a history tab at 330, the blockchain address application may display the history of the NFT 315. The history may include a date at which the NFT 315 was minted (e.g., as the NFT 315 was minted prior to the user accessing the link) and a list of transfers of the NFT 315. For example, the list of transfers may include respective blockchain addresses and dates at which the NFT 315 was transferred to different blockchain addresses (e.g., including the blockchain address of the user).

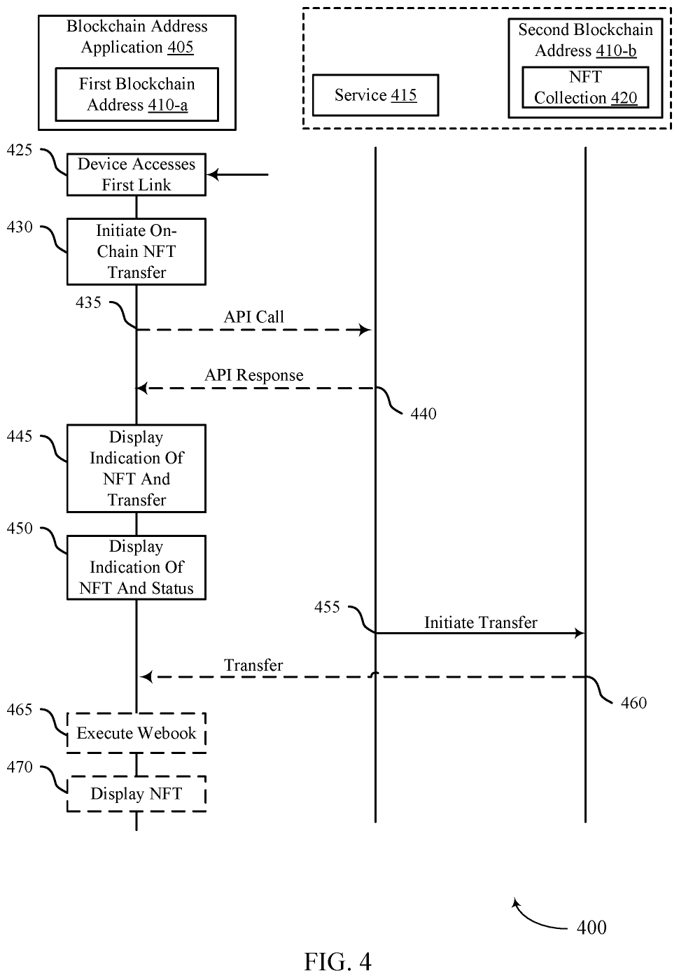

FIG. 4 shows an example of a process flow 400 that supports optimistic receipt of NFTs in a blockchain address application in accordance with aspects of the present disclosure. In some examples, the process flow 400 may implement or be implemented by aspects of the computing environment 100, the computing environment 200, and/or the user interface flow 300 as described with reference to FIGS. 1 through 3. For example, the process flow 400 may include a blockchain address application 405, a first blockchain address 410-a, a second blockchain address 410-b, a service 415, and an NFT collection 420, which may be examples of corresponding aspects as described with reference to FIG. 2.

Alternative examples of the following may be implemented, where some steps are performed in a different order than described or are not performed at all. In some cases, steps may include additional features not mentioned below, or further steps may be added. Although the blockchain address application 405, the first blockchain address 410-a, the second blockchain address 410-b, the service 415, and the NFT collection 420 are shown performing the steps of the process flow 400, some aspects of some operations may also be performed by one or more other components.

At 425, a device may access a first link. For example, the blockchain address application 405 may receive information indicating that a device supporting the blockchain address application accesses the first link associated with the blockchain address application 405. The information may indicate an NFT, such as the NFT 215 or the NFT 315 as described with reference to FIGS. 2 and 3, respectively. In some examples, the first link may be accessible via a QR code or triggered via a detected near field communication (NFC) (or similar technology) tag. For example, the device (e.g., user device 140) may be used to scan the QR code, and the QR code may include information to trigger launching or opening of the blockchain address application 405 on the user device. Similarly, a NFC tag may be detected, and the NFC tag may communicate information that triggers launching or opening of the application or a website.

Additionally, or alternatively, the device may trigger an event, where the event is sent to a proxy authority service. The proxy authority service may monitor for on-chain conditions and initiate transfer of the NFT to the first blockchain address 410-a (e.g., by sending a cryptographically signed message to the service 415). As an example, the proxy authority service may monitor for or a balance (e.g., a quantity of tokens) associated with the first blockchain address 410-a and determine whether the balance satisfies a threshold. That is, the proxy authority service may initiate the transfer of the NFT based on the balance associated with the first blockchain address 410-a meeting the threshold. It should be understood that other types of on-chain conditions may be checked before the transfer or action is triggered. In another example, the device may trigger the event via a private key (e.g., a one-time-use private key) embedded in link distributed in a QR code. When scanned, the device may load a website which may generate a message on the device and submit the message to the service 415 to initiate the transfer of the NFT.

At 430, the blockchain address application 405 may initiate an on-chain NFT transfer. For example, the blockchain address application 405 may initiate execution of an on-chain transfer the NFT from a second blockchain address associated with an NFT collection 420 including the NFT to the first blockchain address associated with the blockchain address application after receiving the information at 425. In some examples, the blockchain address application 405 may initiate execution of the on-chain transfer absent a digital signature from the first blockchain address 410-a. Additionally, or alternatively, the NFT collection 420 including the NFT may be minted to the second blockchain address 410-b prior to the execution of the on-chain transfer of the NFT from the second blockchain address 410-b to the first blockchain address 410-a.

At 435, the blockchain address application 405 may transmit an API call to the service 415. The API call, which may be an example of the API call 225 as described with reference to FIG. 2, may result in execution of the on-chain transfer. In other words, initiating the on-chain transfer of the NFT at 430 may include transmitting the API call at 435. The API call at 435 may include information received via the link, an indication of the first blockchain address 410-a, and/or additional information. In some examples, the blockchain address application 405 may receive an API response from the service 415 at 440. Receipt of the API response at 440 may result in display of one or more indications via a user interface of the device. That is, the API response may include an indication of the NFT and/or instructions to display the NFT via the blockchain address application 405.

At 445, the blockchain address application 405 may display the indication of the NFT and the transfer via a user interface. For example, the blockchain address application 405 may display a first indication of the NFT and a second indication that the NFT is transferred to the first blockchain address 410-a. The display of the first indication and the second indication may be described further elsewhere herein, including with reference to FIG. 3. For example, display of the first indication and the second indication may be illustrated and described at 305 of FIG. 3. In some examples, the blockchain address application 405 may display the first indication and the second indication based on receiving the API response at 440. It should be noted that operations at 430 and 445 may be performed in either order. That is, the blockchain address application 405 display the indication of the NFT prior to initiation of execution of the on-chain transfer of the NFT. Thus, the blockchain address application 405 may obtain the indication of the NFT and display the NFT prior to the on-chain being initiated by the blockchain address application 405, the service 415, or both.

At 450, the blockchain address application 405 may display the indication of the NFT and a status associated with the on-chain transfer via the user interface. For example, the blockchain address application 405 may display an indication of the NFT and, until the on-chain transfer of the NFT is complete, a pending status. The display of the NFT and the pending status may be described in greater detail elsewhere herein, including with reference to FIG. 3. For example, display of the pending status may be illustrated and described at 320 of FIG. 3. In some cases, the user may navigate to an NFT tab or section of the blockchain address application 405 in order to cause display of the NFT and the transfer status. The blockchain address application 405 may display the indication of the NFT absent of the status after confirmation of the on-chain transfer.

At 455, the service 415 may initiate the on-chain transfer of the NFT. For example, the service 415 may initiate the transfer of the NFT from the NFT collection 420 at the second blockchain address 410-b. In some examples, initiating transfer of the NFT from the NFT collection 420 at 445 may include broadcasting one or more messages via a blockchain network, such as the blockchain network 105 as described with reference to FIGS. 1 and 2. In some examples, the second blockchain address 410-b may be associated with a self-executing program supported by the blockchain network. The one or more messages may cause the self-executing program to transfer the NFT. That is, the one or more messages may include a contract call to cause the self-executing program to transfer the NFT. The contract call may include an indication of the NFT, an indication of the recipient address (e.g., the first blockchain address 410-a), or a combination thereof. In some cases, the first blockchain address 410 may be received by the service 415 via the Api call such as to initiate the transfer of the NFT to the blockchain address.

In other words, broadcasting the one or more messages via the blockchain network may result in transfer of the NFT from the second blockchain address 410-b to the first blockchain address 410-a via the blockchain network at 460. In some aspects, the on-chain transfer is executed to transfer the NFT to the first blockchain address 410-a without requiring a second transfer from the first blockchain address 410-a. For example, the on-chain transfer may be executed without a payment from the first blockchain address 410-a. In some examples, the NFT may be restricted from being transferred to another blockchain address.

At 465, the blockchain address application 405 may execute a webhook. For example, the blockchain address application 405 may execute a webhook that triggers execution of a backend process, an on-chain message, or both in response to the on-chain transfer. As an example, the webhook may trigger removal of the pending status, transfer of a second NFT to the first blockchain address 410-a, or both.

At 470, the blockchain address application 405 may display the NFT in response to completion or verification of the transfer of the NFT. Display of the NFT may be without the pending status.

In some examples, the blockchain address application 405 may receive second information indicating that the device supporting the blockchain address application 405 accesses a second link associated with the blockchain address application 405. For example, the information may be indicative of a second NFT. Access to the second link may result in display of the second NFT via the user interface of the blockchain address application 405 and transfer of the second NFT to the first blockchain address. In other words, different links may be associated with different NFTs.

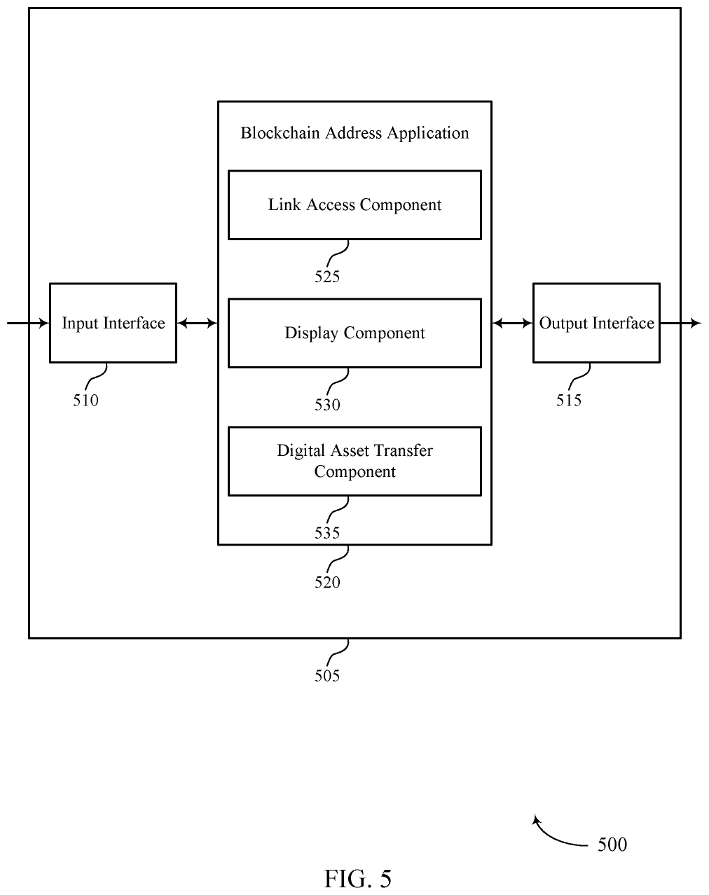

FIG. 5 shows a block diagram 500 of a device 505 that supports optimistic receipt of NFTs in a blockchain address application in accordance with aspects of the present disclosure. The device 505 may include an input interface 510, an output interface 515, and a blockchain address application 520. The device 505, or one or more components of the device 505 (e.g., the input interface 510, the output interface 515, the blockchain address application 520), may include at least one processor, which may be coupled with at least one memory, to support the described techniques. Each of these components may communicate, directly or indirectly, with one another (e.g., via one or more buses, communications links, communications interfaces, or any combination thereof).

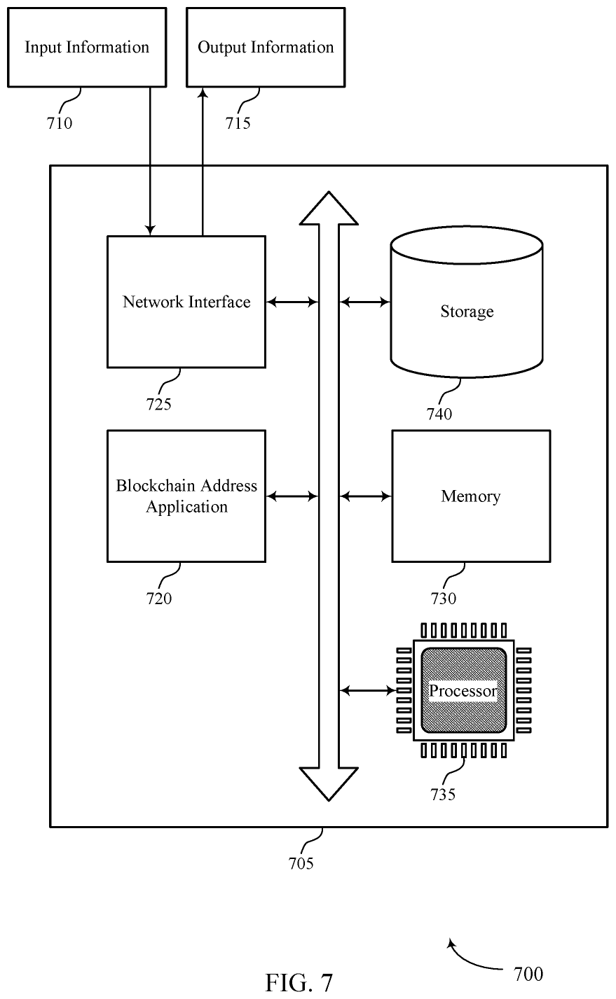

The input interface 510 may manage input signaling for the device 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the device 505 for processing. For example, the input interface 510 may transmit such corresponding signaling to the blockchain address application 520 to support optimistic receipt of NFTs in a blockchain address application. In some cases, the input interface 510 may be a component of a network interface 725 as described with reference to FIG. 7.

The output interface 515 may manage output signaling for the device 505. For example, the output interface 515 may receive signaling from other components of the device 505, such as the blockchain address application 520, and may transmit such output signaling corresponding to (e.g., representative of or otherwise based on) such signaling to other systems or devices. In some cases, the output interface 515 may be a component of a network interface 725 as described with reference to FIG. 7.

For example, the blockchain address application 520 may include a link access component 525, a display component 530, a digital asset transfer component 535, or any combination thereof. In some examples, the blockchain address application 520, or various components thereof, may be configured to perform various operations (e.g., receiving, monitoring, transmitting) using or otherwise in cooperation with the input interface 510, the output interface 515, or both. For example, the blockchain address application 520 may receive information from the input interface 510, send information to the output interface 515, or be integrated in combination with the input interface 510, the output interface 515, or both to receive information, transmit information, or perform various other operations as described herein.

The blockchain address application 520 may support digital asset transfer in accordance with examples as disclosed herein. The link access component 525 may be configured as or otherwise support a means for receiving, at a blockchain address application, information indicating that a device supporting the blockchain address application accesses a first link associated with the blockchain address application, wherein the information indicates a NFT. The display component 530 may be configured as or otherwise support a means for displaying, via a user interface of the blockchain address application, a first indication of the NFT and a second indication that the NFT is transferred to a first blockchain address associated with the blockchain address application. The digital asset transfer component 535 may be configured as or otherwise support a means for initiating, via the blockchain address application after receiving the information, execution of an on-chain transfer the NFT from a second blockchain address associated with an NFT collection comprising the NFT to the first blockchain address associated with the blockchain address application. The display component 530 may be configured as or otherwise support a means for displaying, via the user interface of the blockchain address application, the first indication of the NFT and a status associated with the on-chain transfer, wherein the status is pending until confirmation of the on-chain transfer via a blockchain network.

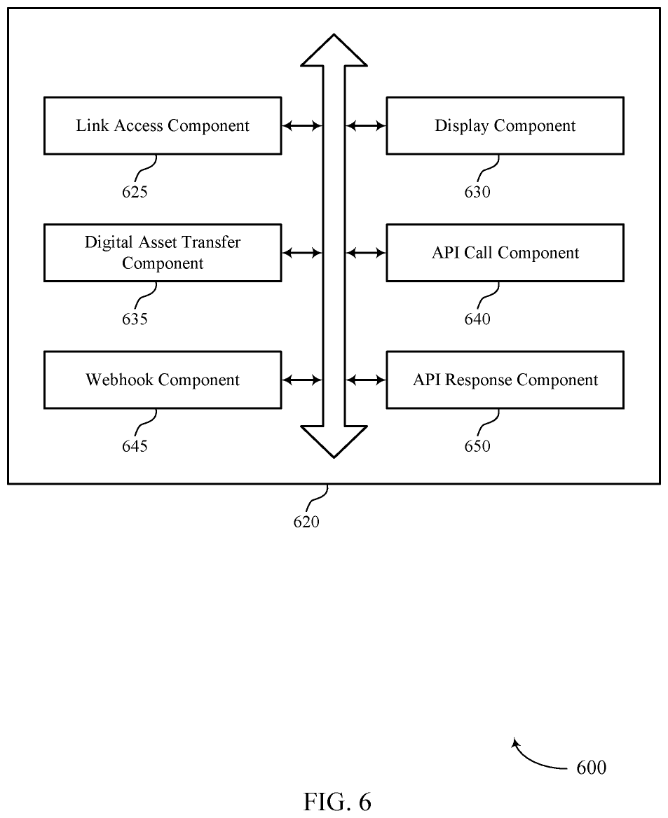

FIG. 6 shows a block diagram 600 of a blockchain address application 620 that supports optimistic receipt of NFTs in a blockchain address application in accordance with aspects of the present disclosure. The blockchain address application 620 may be an example of aspects of a blockchain address application or a blockchain address application 520, or both, as described herein. The blockchain address application 620, or various components thereof, may be an example of means for performing various aspects of optimistic receipt of NFTs in a blockchain address application as described herein. For example, the blockchain address application 620 may include a link access component 625, a display component 630, a digital asset transfer component 635, an API call component 640, a webhook component 645, an API response component 650, or any combination thereof. Each of these components may communicate, directly or indirectly, with one another (e.g., via one or more buses, communications links, communications interfaces, or any combination thereof).

The blockchain address application 620 may support digital asset transfer in accordance with examples as disclosed herein. The link access component 625 may be configured as or otherwise support a means for receiving, at a blockchain address application, information indicating that a device supporting the blockchain address application accesses a first link associated with the blockchain address application, wherein the information indicates a NFT. The display component 630 may be configured as or otherwise support a means for displaying, via a user interface of the blockchain address application, a first indication of the NFT and a second indication that the NFT is transferred to a first blockchain address associated with the blockchain address application. The digital asset transfer component 635 may be configured as or otherwise support a means for initiating, via the blockchain address application after receiving the information, execution of an on-chain transfer the NFT from a second blockchain address associated with an NFT collection comprising the NFT to the first blockchain address associated with the blockchain address application. In some examples, the display component 630 may be configured as or otherwise support a means for displaying, via the user interface of the blockchain address application, the first indication of the NFT and a status associated with the on-chain transfer, wherein the status is pending until confirmation of the on-chain transfer via a blockchain network.

In some examples, to support displaying the NFT after the confirmation of the on-chain transfer, the display component 630 may be configured as or otherwise support a means for displaying the NFT absent of the status, wherein the status is complete after the confirmation of the on-chain transfer via the blockchain network.

In some examples, to support initiating the execution of the on-chain transfer, the API call component 640 may be configured as or otherwise support a means for transmitting an application programming interface (API) call to a service associated with the second blockchain address, wherein the API call results in execution of the on-chain transfer.

In some examples, the API response component 650 may be configured as or otherwise support a means for receiving, in response to the API call, an API response that results in display of the first indication, the second indication, or both via the user interface.

In some examples, the blockchain address application initiates execution of the on-chain transfer absent a digital signature from the first blockchain address.

In some examples, the NFT collection comprising the NFT is minted to the second blockchain address prior to the execution of the on-chain transfer of the NFT from the second blockchain address to the first blockchain address.

In some examples, the webhook component 645 may be configured as or otherwise support a means for executing, by the blockchain address application in response to the on-chain transfer, a webhook that triggers execution of a backend process, an on-chain message, or both.

In some examples, the first link is accessible to the device via a quick response (QR) code.

In some examples, the on-chain transfer is executed to transfer the NFT to the first blockchain address without requiring a second transfer from the first blockchain address.

In some examples, the NFT is restricted from being transferred to another blockchain address.

In some examples, the second blockchain address is associated with a self-executing program supported by the blockchain network.

In some examples, the link access component 625 may be configured as or otherwise support a means for receiving, at the blockchain address application, second information indicating that the device supporting the blockchain address application accesses a second link associated with the blockchain address application, wherein the information is indicative of a second NFT, and wherein the access to the second link results in display of the second NFT via the user interface of the blockchain address application and transfer of the second NFT to the first blockchain address.

FIG. 7 shows a diagram of a system 700 including a device 705 that supports optimistic receipt of NFTs in a blockchain address application in accordance with aspects of the present disclosure. The device 705 may be an example of or include components of a device 505 as described herein. The device 705 may include components for optimistic receipt of NFTs, such as a blockchain address application 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the device 705 to exchange information (e.g., input information 710, output information 715, or both) with other systems or devices (not shown). For example, the network interface 725 may enable the device 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting optimistic receipt of NFTs in a blockchain address application. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the device 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting optimistic receipt of NFTs in a blockchain address application). Though a single processor 735 is depicted in the example of FIG. 7, it is to be understood that the device 705 may include any quantity of one or more of processors 735 and that a group of processors 735 may collectively perform one or more functions ascribed herein to a processor, such as the processor 735. The processor 735 may be an example of a single processor or multiple processors. For example, the device 705 may include one or more processors 735.

Storage 740 may be configured to store data that is generated, processed, stored, or otherwise used by the device 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1.

The blockchain address application 720 may support digital asset transfer in accordance with examples as disclosed herein. For example, the blockchain address application 720 may be configured as or otherwise support a means for receiving, at a blockchain address application, information indicating that a device supporting the blockchain address application accesses a first link associated with the blockchain address application, wherein the information indicates a NFT. The blockchain address application 720 may be configured as or otherwise support a means for displaying, via a user interface of the blockchain address application, a first indication of the NFT and a second indication that the NFT is transferred to a first blockchain address associated with the blockchain address application. The blockchain address application 720 may be configured as or otherwise support a means for initiating, via the blockchain address application after receiving the information, execution of an on-chain transfer the NFT from a second blockchain address associated with an NFT collection comprising the NFT to the first blockchain address associated with the blockchain address application. The blockchain address application 720 may be configured as or otherwise support a means for displaying, via the user interface of the blockchain address application, the first indication of the NFT and a status associated with the on-chain transfer, wherein the status is pending until confirmation of the on-chain transfer via a blockchain network.

By including or configuring the blockchain address application 720 in accordance with examples as described herein, the device 705 may support techniques for improved user experience related to reduced transfer time and immediate display of NFTs.

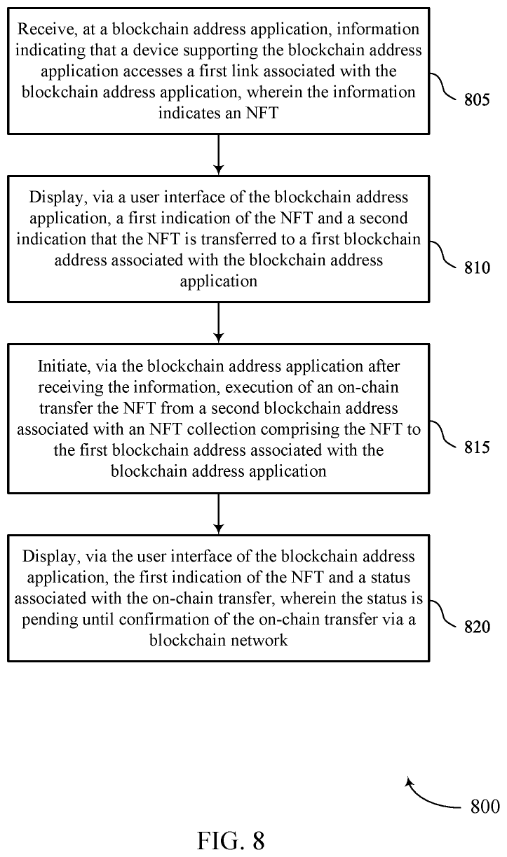

FIG. 8 shows a flowchart illustrating a method 800 that supports optimistic receipt of NFTs in a blockchain address application in accordance with aspects of the present disclosure. The operations of the method 800 may be implemented by a blockchain address application or its components as described herein. For example, the operations of the method 800 may be performed by a blockchain address application as described with reference to FIGS. 1 through 7. In some examples, a blockchain address application may execute a set of instructions to control the functional elements of the blockchain address application to perform the described functions. Additionally, or alternatively, the blockchain address application may perform aspects of the described functions using special-purpose hardware.

At 805, the method may include receiving, at a blockchain address application, information indicating that a device supporting the blockchain address application accesses a first link associated with the blockchain address application, wherein the information indicates a NFT. The operations of 805 may be performed in accordance with examples as disclosed herein. In some examples, aspects of the operations of 805 may be performed by a link access component 625 as described with reference to FIG. 6.

At 810, the method may include displaying, via a user interface of the blockchain address application, a first indication of the NFT and a second indication that the NFT is transferred to a first blockchain address associated with the blockchain address application. The operations of 810 may be performed in accordance with examples as disclosed herein. In some examples, aspects of the operations of 810 may be performed by a display component 630 as described with reference to FIG. 6.

At 815, the method may include initiating, via the blockchain address application after receiving the information, execution of an on-chain transfer the NFT from a second blockchain address associated with an NFT collection comprising the NFT to the first blockchain address associated with the blockchain address application. The operations of 815 may be performed in accordance with examples as disclosed herein. In some examples, aspects of the operations of 815 may be performed by a digital asset transfer component 635 as described with reference to FIG. 6.

At 820, the method may include displaying, via the user interface of the blockchain address application, the first indication of the NFT and a status associated with the on-chain transfer, wherein the status is pending until confirmation of the on-chain transfer via a blockchain network. The operations of 820 may be performed in accordance with examples as disclosed herein. In some examples, aspects of the operations of 820 may be performed by a display component 630 as described with reference to FIG. 6.

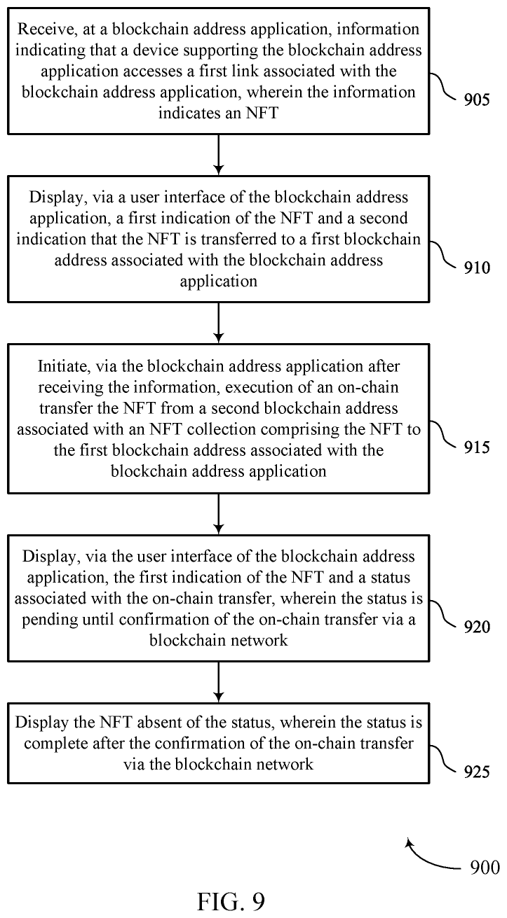

FIG. 9 shows a flowchart illustrating a method 900 that supports optimistic receipt of NFTs in a blockchain address application in accordance with aspects of the present disclosure. The operations of the method 900 may be implemented by a blockchain address application or its components as described herein. For example, the operations of the method 900 may be performed by a blockchain address application as described with reference to FIGS. 1 through 7. In some examples, a blockchain address application may execute a set of instructions to control the functional elements of the blockchain address application to perform the described functions. Additionally, or alternatively, the blockchain address application may perform aspects of the described functions using special-purpose hardware.

At 905, the method may include receiving, at a blockchain address application, information indicating that a device supporting the blockchain address application accesses a first link associated with the blockchain address application, wherein the information indicates a NFT. The operations of 905 may be performed in accordance with examples as disclosed herein. In some examples, aspects of the operations of 905 may be performed by a link access component 625 as described with reference to FIG. 6.

At 910, the method may include displaying, via a user interface of the blockchain address application, a first indication of the NFT and a second indication that the NFT is transferred to a first blockchain address associated with the blockchain address application. The operations of 910 may be performed in accordance with examples as disclosed herein. In some examples, aspects of the operations of 910 may be performed by a display component 630 as described with reference to FIG. 6.

At 915, the method may include initiating, via the blockchain address application after receiving the information, execution of an on-chain transfer the NFT from a second blockchain address associated with an NFT collection comprising the NFT to the first blockchain address associated with the blockchain address application. The operations of 915 may be performed in accordance with examples as disclosed herein. In some examples, aspects of the operations of 915 may be performed by a digital asset transfer component 635 as described with reference to FIG. 6.

At 920, the method may include displaying, via the user interface of the blockchain address application, the first indication of the NFT and a status associated with the on-chain transfer, wherein the status is pending until confirmation of the on-chain transfer via a blockchain network. The operations of 920 may be performed in accordance with examples as disclosed herein. In some examples, aspects of the operations of 920 may be performed by a display component 630 as described with reference to FIG. 6.

At 925, the method may include displaying the NFT absent of the status, wherein the status is complete after the confirmation of the on-chain transfer via the blockchain network. The operations of 925 may be performed in accordance with examples as disclosed herein. In some examples, aspects of the operations of 925 may be performed by a display component 630 as described with reference to FIG. 6.

A method for digital asset transfer by an apparatus is described. The method may include receiving, at a blockchain address application, information indicating that a device supporting the blockchain address application accesses a first link associated with the blockchain address application, wherein the information indicates a NFT, displaying, via a user interface of the blockchain address application, a first indication of the NFT and a second indication that the NFT is transferred to a first blockchain address associated with the blockchain address application, initiating, via the blockchain address application after receiving the information, execution of an on-chain transfer the NFT from a second blockchain address associated with an NFT collection comprising the NFT to the first blockchain address associated with the blockchain address application, and displaying, via the user interface of the blockchain address application, the first indication of the NFT and a status associated with the on-chain transfer, wherein the status is pending until confirmation of the on-chain transfer via a blockchain network.

An apparatus for digital asset transfer is described. The apparatus may include one or more memories storing processor executable code, and one or more processors coupled with the one or more memories. The one or more processors may individually or collectively be operable to execute the code to cause the apparatus to receive, at a blockchain address application, information indicating that a device supporting the blockchain address application accesses a first link associated with the blockchain address application, wherein the information indicates a NFT, display, via a user interface of the blockchain address application, a first indication of the NFT and a second indication that the NFT is transferred to a first blockchain address associated with the blockchain address application, initiate, via the blockchain address application after receiving the information, execution of an on-chain transfer the NFT from a second blockchain address associated with an NFT collection comprising the NFT to the first blockchain address associated with the blockchain address application, and display, via the user interface of the blockchain address application, the first indication of the NFT and a status associated with the on-chain transfer, wherein the status is pending until confirmation of the on-chain transfer via a blockchain network.

Another apparatus for digital asset transfer is described. The apparatus may include means for receiving, at a blockchain address application, information indicating that a device supporting the blockchain address application accesses a first link associated with the blockchain address application, wherein the information indicates a NFT, means for displaying, via a user interface of the blockchain address application, a first indication of the NFT and a second indication that the NFT is transferred to a first blockchain address associated with the blockchain address application, means for initiating, via the blockchain address application after receiving the information, execution of an on-chain transfer the NFT from a second blockchain address associated with an NFT collection comprising the NFT to the first blockchain address associated with the blockchain address application, and means for displaying, via the user interface of the blockchain address application, the first indication of the NFT and a status associated with the on-chain transfer, wherein the status is pending until confirmation of the on-chain transfer via a blockchain network.

A non-transitory computer-readable medium storing code for digital asset transfer is described. The code may include instructions executable by one or more processors to receive, at a blockchain address application, information indicating that a device supporting the blockchain address application accesses a first link associated with the blockchain address application, wherein the information indicates a NFT, display, via a user interface of the blockchain address application, a first indication of the NFT and a second indication that the NFT is transferred to a first blockchain address associated with the blockchain address application, initiate, via the blockchain address application after receiving the information, execution of an on-chain transfer the NFT from a second blockchain address associated with an NFT collection comprising the NFT to the first blockchain address associated with the blockchain address application, and display, via the user interface of the blockchain address application, the first indication of the NFT and a status associated with the on-chain transfer, wherein the status is pending until confirmation of the on-chain transfer via a blockchain network.

In some examples of the method, apparatus, and non-transitory computer-readable medium described herein, displaying the NFT after the confirmation of the on-chain transfer may include operations, features, means, or instructions for displaying the NFT absent of the status, wherein the status may be complete after the confirmation of the on-chain transfer via the blockchain network.

In some examples of the method, apparatus, and non-transitory computer-readable medium described herein, initiating the execution of the on-chain transfer may include operations, features, means, or instructions for transmitting an application programming interface (API) call to a service associated with the second blockchain address, wherein the API call results in execution of the on-chain transfer.

Some examples of the method, apparatus, and non-transitory computer-readable medium described herein may further include operations, features, means, or instructions for receiving, in response to the API call, an API response that results in display of the first indication, the second indication, or both via the user interface.

In some examples of the method, apparatus, and non-transitory computer-readable medium described herein, the blockchain address application initiates execution of the on-chain transfer absent a digital signature from the first blockchain address.

In some examples of the method, apparatus, and non-transitory computer-readable medium described herein, the NFT collection comprising the NFT may be minted to the second blockchain address prior to the execution of the on-chain transfer of the NFT from the second blockchain address to the first blockchain address.

Some examples of the method, apparatus, and non-transitory computer-readable medium described herein may further include operations, features, means, or instructions for executing, by the blockchain address application in response to the on-chain transfer, a webhook that triggers execution of a backend process, an on-chain message, or both.

In some examples of the method, apparatus, and non-transitory computer-readable medium described herein, the first link may be accessible to the device via a quick response (QR) code.

In some examples of the method, apparatus, and non-transitory computer-readable medium described herein, the on-chain transfer may be executed to transfer the NFT to the first blockchain address without requiring a second transfer from the first blockchain address.

In some examples of the method, apparatus, and non-transitory computer-readable medium described herein, the NFT may be restricted from being transferred to another blockchain address.

In some examples of the method, apparatus, and non-transitory computer-readable medium described herein, the second blockchain address may be associated with a self-executing program supported by the blockchain network.

Some examples of the method, apparatus, and non-transitory computer-readable medium described herein may further include operations, features, means, or instructions for receiving, at the blockchain address application, second information indicating that the device supporting the blockchain address application accesses a second link associated with the blockchain address application, wherein the information may be indicative of a second NFT, and wherein the access to the second link results in display of the second NFT via the user interface of the blockchain address application and transfer of the second NFT to the first blockchain address.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for digital asset transfer, comprising:
receiving, at a blockchain address application, information indicating that a device supporting the blockchain address application accesses a first link associated with the blockchain address application, wherein the information indicates a non-fungible token (NFT);
displaying, via a user interface of the blockchain address application, a first indication of the NFT and a second indication that the NFT is transferred to a first blockchain address associated with the blockchain address application;
initiating, via the blockchain address application after receiving the information, execution of an on-chain transfer the NFT from a second blockchain address associated with an NFT collection comprising the NFT to the first blockchain address associated with the blockchain address application; and
displaying, via the user interface of the blockchain address application, the first indication of the NFT and a status associated with the on-chain transfer, wherein the status is pending until confirmation of the on-chain transfer via a blockchain network.

2. The method of claim 1, wherein displaying the NFT after the confirmation of the on-chain transfer comprises:
displaying the NFT absent of the status, wherein the status is complete after the confirmation of the on-chain transfer via the blockchain network.

3. The method of claim 1, wherein initiating the execution of the on-chain transfer comprises:
transmitting an application programming interface (API) call to a service associated with the second blockchain address, wherein the API call results in execution of the on-chain transfer.

4. The method of claim 3, further comprising:
receiving, in response to the API call, an API response that results in display of the first indication, the second indication, or both via the user interface.

5. The method of claim 1, wherein the blockchain address application initiates execution of the on-chain transfer absent a digital signature from the first blockchain address.

6. The method of claim 1, wherein the NFT collection comprising the NFT is minted to the second blockchain address prior to the execution of the on-chain transfer of the NFT from the second blockchain address to the first blockchain address.

7. The method of claim 1, further comprising:
executing, by the blockchain address application in response to the on-chain transfer, a webhook that triggers execution of a backend process, an on-chain message, or both.

8. The method of claim 1, wherein the first link is accessible to the device via a quick response (QR) code.

9. The method of claim 1, wherein the on-chain transfer is executed to transfer the NFT to the first blockchain address without requiring a second transfer from the first blockchain address.

10. The method of claim 1, wherein the NFT is restricted from being transferred to another blockchain address.

11. The method of claim 1, wherein the second blockchain address is associated with a self-executing program supported by the blockchain network.

12. The method of claim 1, further comprising:
receiving, at the blockchain address application, second information indicating that the device supporting the blockchain address application accesses a second link associated with the blockchain address application, wherein the information is indicative of a second NFT, and wherein the access to the second link results in display of the second NFT via the user interface of the blockchain address application and transfer of the second NFT to the first blockchain address.

13. An apparatus for digital asset transfer, comprising:
one or more memories storing processor-executable code; and
one or more processors coupled with the one or more memories and individually or collectively operable to execute the code to cause the apparatus to:
receive, at a blockchain address application, information indicating that a device supporting the blockchain address application accesses a first link associated with the blockchain address application, wherein the information indicates a non-fungible token (NFT);
display, via a user interface of the blockchain address application, a first indication of the NFT and a second indication that the NFT is transferred to a first blockchain address associated with the blockchain address application;
initiate, via the blockchain address application after receiving the information, execution of an on-chain transfer the NFT from a second blockchain address associated with an NFT collection comprising the NFT to the first blockchain address associated with the blockchain address application; and
display, via the user interface of the blockchain address application, the first indication of the NFT and a status associated with the on-chain transfer, wherein the status is pending until confirmation of the on-chain transfer via a blockchain network.

14. The apparatus of claim 13, wherein, to display the NFT after the confirmation of the on-chain transfer, the one or more processors are individually or collectively operable to execute the code to cause the apparatus to:
display the NFT absent of the status, wherein the status is complete after the confirmation of the on-chain transfer via the blockchain network.

15. The apparatus of claim 13, wherein, to initiate the execution of the on-chain transfer, the one or more processors are individually or collectively operable to execute the code to cause the apparatus to:
transmit an application programming interface (API) call to a service associated with the second blockchain address, wherein the API call results in execution of the on-chain transfer.

16. The apparatus of claim 15, wherein the one or more processors are individually or collectively further operable to execute the code to cause the apparatus to:
receive, in response to the API call, an API response that results in display of the first indication, the second indication, or both via the user interface.

17. A non-transitory computer-readable medium storing code for digital asset transfer, the code comprising instructions executable by one or more processors to:
receive, at a blockchain address application, information indicating that a device supporting the blockchain address application accesses a first link associated with the blockchain address application, wherein the information indicates a non-fungible token (NFT);
display, via a user interface of the blockchain address application, a first indication of the NFT and a second indication that the NFT is transferred to a first blockchain address associated with the blockchain address application;
initiate, via the blockchain address application after receiving the information, execution of an on-chain transfer the NFT from a second blockchain address associated with an NFT collection comprising the NFT to the first blockchain address associated with the blockchain address application; and
display, via the user interface of the blockchain address application, the first indication of the NFT and a status associated with the on-chain transfer, wherein the status is pending until confirmation of the on-chain transfer via a blockchain network.

18. The non-transitory computer-readable medium of claim 17, wherein the blockchain address application initiates execution of the on-chain transfer absent a digital signature from the first blockchain address.

19. The non-transitory computer-readable medium of claim 17, wherein the NFT collection comprising the NFT is minted to the second blockchain address prior to the execution of the on-chain transfer of the NFT from the second blockchain address to the first blockchain address.

20. The non-transitory computer-readable medium of claim 17, wherein the instructions are further executable by the one or more processors to:
execute, by the blockchain address application in response to the on-chain transfer, a webhook that triggers execution of a backend process, an on-chain message, or both.
